(19) United States
(12) Patent Application Publication
(10) Pub. No.: US 2026/0357947 A1
(43) Pub. Date: Nov. 12, 2026

(54) FLEXIBLE AWNING HANGER

(71) Applicant: CAMCO MANUFACTURING, LLC, Greensboro, NC (US)

(72) Inventors: Brandon Blakely, Burlington, NC (US); Niko Jovicevic, Statesville, NC (US)

(21) Appl. No.: 19/200,307

(22) Filed: May 6, 2025

(51) Int. Cl. F16M 13/02

(52) U.S. Cl. CPC F16M 13/022

(57) ABSTRACT

A flexible awning hanger comprising a flexible strap and a detachable hook designed to enhance RV users' ability to hang items from RV awnings. The flexible strap including a barrel structure at a first end, designed to interface with RV awning channels. The flexible nature of the flexible strap allowing the flexible awning hanger to be rolled up in the RV awning without being removed. The flexible strap further including a through window with a locking tab, enabling the flexible strap to be curled and secured at adjustable diameters with multiple locking windows. The flexible awning strap further including the detachable hook at a second end. The detachable hook including a pop rivet that interfaces with an aperture of the flexible strap for attachment, providing versatility in suspending items such as lights and signs.

### TECHNICAL FIELD

The present disclosure relates generally to recreational vehicle (RV) awning hangers. In particular, some aspects of the disclosure may relate to systems for hanging various items using a flexible awning hanger.

### DESCRIPTION OF RELATED ART

Recreational vehicles (RVs) are widely favored by travelers for their ability to combine mobility with comfort. Many conventional RVs include awnings. An RV awning is typically a retractable or extendable covering attached to the side of the vehicle, used to create a shaded outdoor space. RV awnings are often constructed from robust materials, such as vinyl or acrylic, and are designed to withstand various weather conditions, providing protection from sun and rain. RV awnings are typically rolled up into cylindrical tubing attached to the RV. These cylindrical tubes often including an opening along a side of the tubing creating a channel.

A popular practice among RV users is decorating their awnings with string lights to create an inviting atmosphere during evening hours. This decorative process often involves attaching lights to the awning's edges or framework using clips, hooks, or similar fasteners. However, traditional methods can be challenging and may risk damage to both the awning and the lights. The need for a convenient and secure solution has led to innovations in RV accessory design, including specialized hangers for this purpose.

### BRIEF SUMMARY OF THE DISCLOSURE

Embodiments of the present disclosure may include a flexible awning hanger system for hanging items from an awning or pole. The flexible awning hanger may include a flexible strap constructed from a material capable of bending and looping, a barrel structure disposed at a first end of the flexible strap, wherein the barrel structure includes a first side barrel structure and a second side barrel structure, separated by a break, and wherein an edge of the first side and second side barrel structure extends beyond an edge of the flexible strap, a hook attachable to the flexible strap via a pop rivet securable to an aperture disposed through a second end of the flexible strap, and a through window including a locking tab positioned on the flexible strap and configured for the flexible strap to pass through and engage with a locking window on the flexible strap.

Further embodiments of the flexible awning hanger may include wherein the flexible strap material is selected from the group consisting of rubber, silicone, and flexible polymers, wherein the flexible strap further includes an aperture and the injection-molded polymer hook further includes a pop rivet, wherein the pop rivet and aperture are complementarily engageable. The flexible awning hanger may further include wherein the barrel structure is cylindrical and of a dimension to fit within a body of the awning without passing through the channel of the awning, and wherein the barrel structure is configured to slide across the channel of the awning. The flexible awning hanger may further include wherein the locking tab is integrally formed within the locking window. The flexible awning hanger may further include where the first end of the flexible strap is opposite a second end of the flexible strap, and wherein the second end of the flexible strap include the injection-molded polymer hook. Further, the barrel structure may include a break, which separates the barrel structure into a first side and a second side.

Embodiments of the present disclosure may include a system for mounting items onto cylindrical objects or awning channels. The system may include a flexible strap constructed for a material capable of bending and looping, a detachable hook made from polymer and securable to the flexible strap, a barrel structure of a geometry to engage the awning channel, and a through window with a locking tab integrated into the flexible strap, wherein the flexible strap may be configured to loop through and secure at different positions.

Further embodiments of the system may include a plurality of locking windows, wherein the locking windows are securable to the locking tab when passed through the through window, wherein the flexible strap is selected from the group consisting of rubber, silicone, and flexible polymers, wherein the flexible strap further includes an aperture and the detachable hook further includes a pop rivet, wherein the pop rivet and the aperture may be complimentarily engageable, wherein the barrel structure is cylindrical, and wherein a first end of the flexible strap may be opposite a second end of the flexible strap, and wherein the first end of the flexible strap may comprise the barrel structure and the second end of the flexible strap may include the injection-molded polymer hook.

Embodiments of the present disclosure may include a method of using a flexible awning hanger to suspend items from an awning channel. The method may include providing a flexible strap made of resilient material and a detachable injection-molded polymer hook, positioning a barrel structure at a first end of the flexible strap for interfacing with the awning channel, looping the flexible strap through a through window with a locking tab and engaging the locking tab with a locking window on the flexible strap, attaching the detachable injection-molded polymer hook to the flexible strap via a complementary pop rivet and aperture system, and suspending items by the detachable injection-molded polymer hook.

Further embodiments of the present disclosure may include rotating the detachable injection-molded polymer hook relative to the flexible strap, adjusting the flexible strap length to fit varying cylindrical diameters, wherein adjusting the flexible strap length includes disconnecting the locking tab from a first locking window, sliding the flexible strap further through the through window, and engaging the locking tab with a second locking window. The method may further include sliding the barrel structure into the awning channel and placing a second flexible awning strap in the awning channel.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are solely defined by the claims attached hereto and their equivalents thereof.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts a diagram of a front perspective view an example flexible awning hanger, in accordance with various embodiments of the present disclosure.

FIG. 2 depicts a diagram of a rear perspective view of an example flexible awning hanger, in accordance with various embodiments of the present disclosure.

FIG. 3 depicts a diagram of a perspective view of an example flexible strap, in accordance with various embodiments of the present disclosure.

FIG. 4 depicts a diagram of a perspective view of an example hook, in accordance with various embodiments of the present disclosure.

FIG. 5 depicts a diagram of a side plan view of an example hook interfacing with a flexible strap, in accordance with various embodiments of the present disclosure.

The figures are not exhaustive and do not limit the present disclosure to the precise form disclosed.

### DETAILED DESCRIPTION

Embodiments of the present disclosure may include a flexible awning hanger that addresses challenges faced by RV users in relation to hanging and placement of lights, signs, and other hangable items hung from RV awnings. The flexible awning hanger may include a flexible strap and a detachable hook, which may be designed to interface with RV awning slots or cylindrical objects less than several inches in diameter. The flexible strap may be made from materials such as rubber, silicone, or flexible polymers, allowing it to adapt to various diameters through a looping lock design.

The flexible strap may include a barrel structure on a first end that may more easily fit into an awning channel, along with a through window with a locking tab, which may enable more secure and adjustable attachment of hangable items. This design may allow the flexible awning hanger to remain installed within the awning channel even when the awning is rolled up, unlike conventional hangers that may require removal prior to collapsing the RV awning. The detachable hook may be an injection-molded polymer and may snap, via a pop rivet, directly into an aperture on the second end of the flexible strap. The combination of flexible straps, removable hooks, and adjustable locking mechanisms may offer an improved solution for RV users looking to enhance their outdoor spaces with decorative or functional accessories.

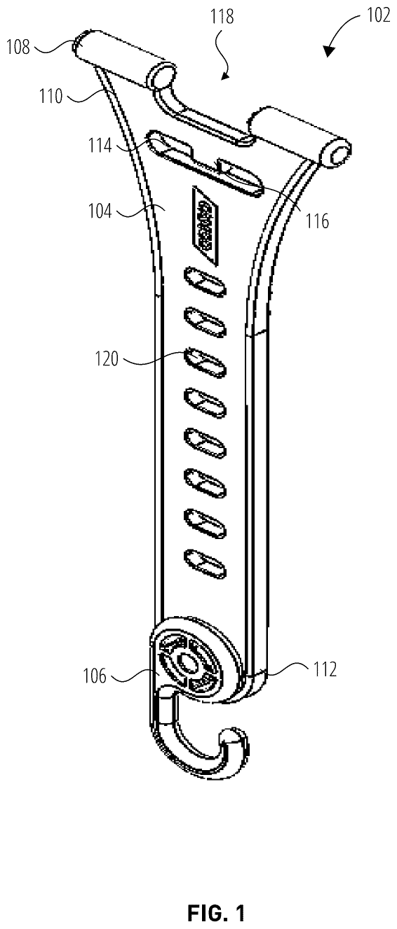

FIG. 1 depicts a diagram of a front perspective view an example flexible awning hanger 102, in accordance with various embodiments of the present disclosure. The flexible awning hanger 102 may be a versatile system designed to more efficiently hang items, such as lights or signs, from RV awnings or similar cylindrical, elevated objects. The flexible awning hanger 102 may include a flexible strap 104. The flexible strap 104 may be constructed from resilient materials, such as rubber, silicone, or flexible polymers, which may provide the flexibility to loop and secure the flexible strap 104 around different objects.

At a first end of the flexible strap 110 may be a barrel structure 108. The barrel structure 108 may be a cylindrical feature extending beyond the first end of the flexible strap 110. The barrel structure 108 may interface with RV awning channels, allowing the flexible awning hanger 102 to remain installed even when the RV awning is rolled up. Additionally, the barrel structure 108 may allow the flexible awning hanger 102 to slide horizontally through the RV awnings and be disposed at various points along the RV awning channel. The barrel structure 108 may be divided by a break 118, which may separate the barrel structure 108 into a first side and a second side. This separation may improve barrel structure 108 engagement with the RV awning channel, ensuring the flexible awning hanger 102 can be slid into the RV awning channel even with minimal maneuverability space. For example, the entry point of the RV awning channel may be corned between edges of the RV and other RV accessories. In such an example, the first side of barrel structure may be slid into the RV awning channel, while the second side of barrel structure may be angled to accomodate entry. Upon completion of entry by the first side of barrel structure, the second side of barrel structure can be angled appropriately to be slid into the RV awning channel.

The second end of the flexible strap 112 may be opposite (length-wise) the first end of the flexible strap 110. The second end of the flexible strap 112 may include the detachable hook 106. The detachable hook 106 may be constructed from an injection-molded polymer, various plastics, and/or metal. The detachable hook 106 may also be constructed from polymer that is not injection-molded. The detachable hook 106 may snap into an aperture of the flexible strap 104, providing a repeatable mechanism to attach and detach the hook 106 from the flexible strap 104. The detachable nature of the hook 106 may allow RV users to remove the hook 106 to insert the second end of the flexible strap 112 through a through window 114 when securing the flexible strap 104 around an object. After insertion of the second end of the flexible strap 112 through the through window 114, the RV user may reattach the detachable hook 106, which may further secure the flexible strap in the looped configuration.

The through window 114 may be an opening through which the second end of the flexible strap 112 can be fed through to create a loop. A locking tab 116 may be positioned within the through window 114, which may secure the flexible strap 104 when inserted therethrough. The locking tab 116 may be on a first edge of the through window 114. For example, the through window 114 may include two longer, flat edges and two narrower, rounded edges (longer and narrower made in reference to each other). The through window 114 may be disposed on the longer, flat edge either closer to the first end of the flexible strap or second end of the flexible strap. As depicted in FIG. 1, the locking tab 116 may be disposed on the longer, flat edge closer to the first end of the flexible strap 110.

The central area of the flexible strap 104 may include locking windows 120. The locking windows 120 may be positioned along the flexible strap 104, allowing the user to adjust the diameter of the loop by selecting the appropriate locking window 120 for the locking tab 116 to engage. The flexible strap 104 may include various numbers of locking windows 120. For example, as depicted in FIG. 1, the flexible strap 104 may include eight locking windows 120, distributed along the flexible strap 104. Further embodiments of the present disclosure may include anywhere from zero to forty locking windows. The locking windows 120 may be evenly spaced from each other, or may be spaced at varying increments based on expected usage. For example, groupings of two locking windows may be placed at discrete increments from one another to provide for more minor adjustments in diameter across greater, more significant distances between the groupings.

The locking windows 120 may be smaller in width and length compared to the through window 114, which may allow the flexible strap 104 to pass through the through window 114 and engage the locking windows. This design may reduce slippage and maintain the structural integrity of the looped strap under varying loads.

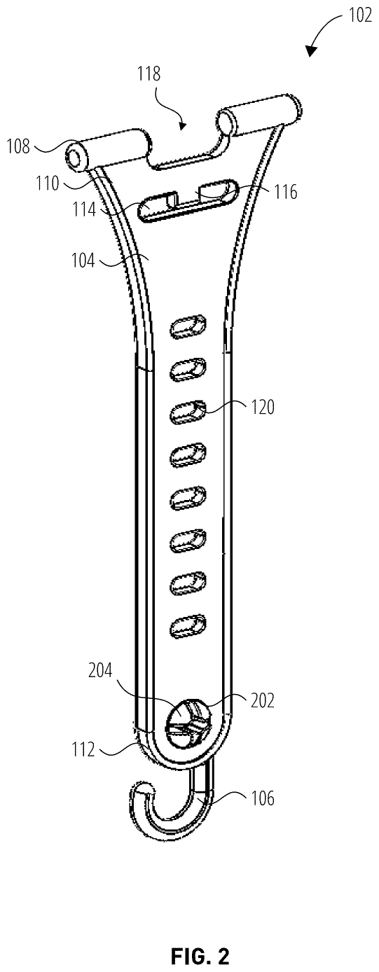

FIG. 2 depicts a diagram of a rear perspective view of an example flexible awning hanger 102, in accordance with various embodiments of the present disclosure. Similarly to FIG. 1, the flexible awning hanger 102 may include a flexible strap 104, a detachable hook 106, barrel structures 108, a first and second end of the flexible strap 110, 112, a through window 114, a locking tab 116, a break 118, and multiple locking windows 120. However, notably, FIG. 2 further includes an aperture 202 and a pop rivet 204.

The aperture 202 may be a substantially circular hole integrated into the second end of the flexible strap 112. Alternatively, the aperture 202 may be other shaped holes appropriate for the complementary attachment mechanism. For example, the aperture may be substantially square shaped for attachment to a buckle-based attachment mechanism. The aperture 202 may serve as a connection point for the detachable hook 106. The aperture 202 may be engineered to accommodate a pop rivet 204 or similar fastening mechanism from the hook 106, which may improve secure attachment between the hook 106 and the flexible strap 104. The placement and circular shape of the aperture 202 may allow for more optimal alignment and engagement with the detachable hook 106, facilitating an easier installation and removal while maintaining the overall integrity and functionality of the flexible awning hanger. The aperture 202 may be of a diameter appropriate such that the detachable hook 106 remains attached to the flexible strap 104 during use.

The pop rivet 204 may be a fastening mechanism designed to complement the aperture 202 located at the second end of the flexible strap 112. The pop rivet 204 may be constructed from durable materials, such an injection-molded polymer, plastics, and/or metal, and may improve the stable connection between the flexible strap 104 and the detachable hook 106. The pop rivet 204 may be designed to expand and lock into place once inserted through the aperture 202, minimizing unintended disconnection during use. The pop rivet 204 may provide a robust attachment point, allowing the detachable hook to more reliably support various items hung from the flexible awning hanger. Alternative fastening elements may also be used in place of the pop rivet, for example, a screw or locking rivet may be used for more permanent installations.

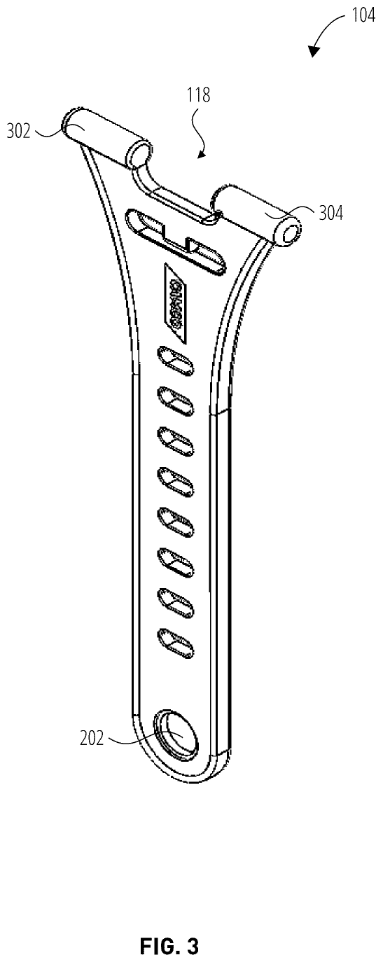

FIG. 3 depicts a diagram of a perspective view of an example flexible strap 104, in accordance with various embodiments of the present disclosure. Similarly to FIGS. 1-2, the flexible strap 104 may include a break 118 and an aperture 202. However, notably, FIG. 3 may depict the aperture 202 from a front perspective without the detachable hook secured therein. In such configurations, the second end of the flexible strap may be fed through the through window, without the detachable hook interfering with insertion.

Furthermore, the barrel structure may include a first side of the barrel structure 302 and a second side of the barrel structure 304, which, as discussed, may improve insertion of the barrel structure into an RV awning channel. The first side of the barrel structure 302 and the second side of the barrel structure 304 may be separated by a break 118, which may be a depression into the first end of the flexible strap 104. Additionally, edges of the first side of the barrel structure 302 and edges of the second side of the barrel structure 304 may extend laterally outward beyond edges of the flexible strap to improve stability of the flexible awning hanger when inserted into the RV awning channel.

Additionally, the barrel structure may be cylindrical and of a dimension to fit within a body of the awning without passing through the channel of the awning. In other words, the awning may be a hollow tube with a channel or cute laterally placed through the body. The interior of the body of the awning may be of a greater diameter than the width of the channel. For example, the interior diameter of the awning may be approximately four inches, whereas the channel may be approximately half an inch in width. In such embodiments, the barrel structure may be of a small enough size to fit within the body of the awning, but also of a large enough size not to slip out of the channel. Moreover, the barrel structure may be configured to slide across the channel of the awning such that when the barrel structure is enclosed within the body of the awning, the flexible strap may extend out from the awning via the channel with sufficient clearance to laterally slide the flexible awning hanger without removing the flexible awning hanger from the awning.

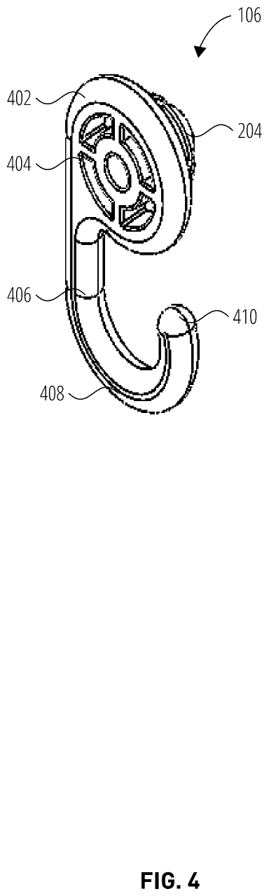

FIG. 4 depicts a diagram of a perspective view of an example hook 106, in accordance with various embodiments of the present disclosure. The hook 106 may be constructed from an injection-molded polymer, various plastics, and/or metals. The hook 106 may be constructed from any one listed or similar material, or a combination of listed or similar materials. The hook 106 may include a body 402, which may be the central frame of the hook 106 from which other features of the hook 106 may be attached or integrated.

The hook 106 may include a face 404, which may be the front portion of the body 402. Opposite the face 404 may be the pop rivet 204, which may be integrated into the body 402 of the hook 106. The face 404 may be a portion of the pop rivet 204 that does not interact with the flexible strap. The pop rivet 204 may secure the hook 106 to the flexible strap via the aperture.

Extending outward from the body 402 may be a shank 406, which may be an elongated member that provides length between the body 402 and the bend 408 or point 410. The length of the shank 406 may be determined based on the desired use of the hook. For example, when stringing lights through the hook, the shank may be a shorter length as string lights are relatively narrow in diameter. Alternatively, if a user were to hang a sign using the hook, a longer shank length may be desirable based on positioning of holes or apertures in the sign. The shank 406 may be a fixed length or may be adjustable.

The shank 406 may transition into a bend 408, which may be a curved feature that allows the hook to wrap around and support objects while suspended. This curvature may be designed to accomodate different shapes and sizes of hanging items.

The hook 106 may further include a point 410, which may be located at the end of the bend 408 and be curved upward (or toward the body 402). The upward curvature may serve a function by preventing objects from slipping off the hook, thereby securing them in place. The structure of the shank 406, bend 408, and point 410 may improve retention of items when subjected to movement or environmental factors.

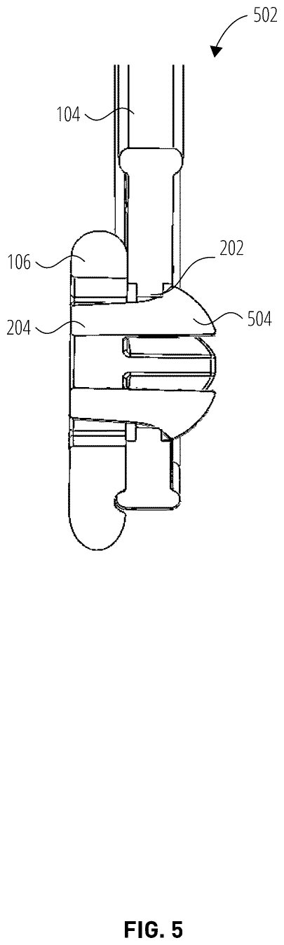

FIG. 5 depicts a diagram of a side plan view of an example hook 106 interfacing with a flexible strap 104, in accordance with various embodiments of the present disclosure. The detachable hook 106 may interact via the pop rivet 204 structure through the flexible strap 502. As discussed, the flexible strap 104 may include an aperture 202 that may be of a size to accomodate a pop rivet 204, or similar attachable mechanism.

The pop rivet 204, integrated within the hook 106, may serve as an attachment mechanism that engages the aperture 202 on the flexible strap 104. The pop rivet 204 may include pop rivet arms 504, which may be depressed together during insertion. The structure of the pop rivet arms 504 may allow the pop rivet 204 to enter the aperture 202, and once inside, the pop rivet arms 504 may expand, securing the hook 106 within the aperture 202.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

The terms “approximately” and “substantially” are used to account for variations that may occur due to manufacturing tolerances, measurement inaccuracies, and other practical considerations in implementing the described technology. The term “approximately” refers to a value or range that is close to the stated value but allows for minor deviations, typically within ±10%, unless otherwise specified, that do not materially affect the function or purpose of the invention. Similarly, the term “substantially” is used to indicate that a particular feature, characteristic, or result is largely present or achieved, with allowable variations without deviating from the intended scope and function of the invention. These terms should be interpreted in a manner consistent with the understanding of a person skilled in the art.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A flexible awning hanger system for hanging items from an awning or pole, comprising:
a flexible strap constructed from a material capable of bending and looping;
a barrel structure disposed at a first end of the flexible strap, wherein the barrel structure comprises a first side barrel structure and a second side barrel structure, separated by a break, and wherein an edge of the first side and second side barrel structure extends beyond an edge of the flexible strap;
a hook attachable to the flexible strap via a pop rivet securable to an aperture disposed through a second end of the flexible strap; and
a through window comprising a locking tab positioned on the flexible strap and configured for the flexible strap to pass through and engage with a locking window on the flexible strap.

2. The flexible awning hanger system of claim 1, wherein the flexible strap material is selected from the group consisting of rubber, silicone, and flexible polymers.

3. The flexible awning hanger system of claim 1, wherein the aperture and the pop rivet are complementarily engageable.

4. The flexible awning hanger system of claim 1, wherein the barrel structure is cylindrical and of a dimension to fit within a body of the awning without passing through the channel of the awning, and wherein the barrel structure is configured to slide across the channel of the awning.

5. The flexible awning hanger system of claim 1, wherein the locking tab is integrally formed within the through window.

6. The flexible awning hanger system of claim 1, further comprising a plurality of locking windows.

7. The flexible awning hanger system of claim 6, wherein the locking windows are securable to the locking tab when passed through the through window.

8. A flexible awning hanger, comprising:
a flexible strap;
a detachable hook securable to the flexible strap;
a barrel structure disposed on a first end of the flexible strap and of a geometry to engage an awning channel; and
a through window integrated into the flexible strap comprising a locking tab, wherein the flexible strap is configured to loop through the through window and secure at different positions via a locking window.

9. The flexible awning hanger of claim 8, further comprising a plurality of locking windows.

10. The flexible awning hanger of claim 9, wherein the locking windows are securable to the locking tab when passed through the through window.

11. The flexible awning hanger of claim 8, wherein the flexible strap is selected from the group consisting of rubber, silicone, and flexible polymers.

12. The flexible awning hanger of claim 8, wherein the flexible strap further comprises an aperture and the detachable hook further comprises a pop rivet, wherein the pop rivet and the aperture are complementarily engageable.

13. The flexible awning hanger of claim 8, wherein the barrel structure is cylindrical.

14. The flexible awning hanger of claim 8, wherein the first end of the flexible strap is opposite a second end of the flexible strap, and wherein the first end of the flexible strap comprises the barrel structure and the second end of the flexible strap comprises the detachable hook.

15. A method of using a flexible awning hanger to suspend items from an awning channel, comprising:
providing a flexible strap made of resilient material and a detachable injection-molded polymer hook;
positioning a barrel structure at a first end of the flexible strap for interfacing with the awning channel;
looping the flexible strap through a through window with a locking tab and engaging the locking tab with a locking window on the flexible strap;
attaching the detachable injection-molded polymer hook to the flexible strap via a complementary pop rivet and aperture system; and
suspending items by the detachable injection-molded polymer hook.

16. The method of claim 15, further comprising rotating the injection-molded polymer hook relative to the flexible strap.

17. The method of claim 15, further comprising adjusting the flexible strap length to fit varying cylindrical diameters.

18. The method of claim 15, wherein adjusting the flexible strap length comprises disconnecting the locking tab from a first locking window, sliding the flexible strap further through the through window, and engaging the locking tab with a second locking window.

19. The method of claim 15, further comprising sliding the barrel structure into the awning channel.

20. The method of claim 15, further comprising placing a second flexible awning strap in the awning channel.
